(19) United States
(12) Patent Application Publication
(10) Pub. No.: US 2016/0206959 A1
(43) Pub. Date: Jul. 21, 2016

(54) CUSTOMIZING A GAME ENTITY ASSOCIATED WITH A PHYSICAL OBJECT AT A POINT OF PURCHASE

(71) Applicant: Disney Enterprises, Inc., Burbank, CA (US)

(72) Inventor: Robert NELSON, Studio City, CA (US)

(21) Appl. No.: 14/598,218

(22) Filed: Jan. 15, 2015

(51) Int. Cl. A63F 13/58

(52) U.S. Cl. CPC A63F 13/58

(57) ABSTRACT

A system and method for customizing a game entity that is played in a video game are disclosed. The video game may take place in a virtual space. Users may access the virtual space via computing platforms. Users may participate in the video game by controlling game entities in the virtual space. Individual ones of the game entities may be associated with a physical object that stores information related to the associated game entities. The stored information may be implemented by virtue of a computing platform receiving the stored information. The stored information may include information related to a customization of the associated game entity that is purchased by a user at a retail location. At least some of the stored information may be written to the physical object using a read/write platform that is included at a point of purchase computing platform in the retail location.

### FIELD OF THE DISCLOSURE

This disclosure relates to customizing game entities that are played by users in a video game by storing customization information on a physical object that is associated with an individual one of the game entities at a retail location.

### BACKGROUND

Relating physical objects to virtual spaces can enrich a user's experience with both the physical object and the virtual space. The physical objects may be used to store information relating to a game entity associated with the physical object and the virtual space. The virtual space may include a video game taking place in the virtual space. The physical objects may be a physical representation of a game entity (e.g., virtual character) used in the virtual space. The information stored by the physical objects may include information related to gameplay using the associated game entity in the virtual space. For example, gameplay using the associated game entity may result in one or more parameters (e.g., related to appearance, abilities, behaviors, and/or other considerations) of the game entity being upgraded through one or more achievements during gameplay. The information related to the upgrades through gameplay may be communicated to, and stored by, the physical object. This may allow a user to physically transport information related to gameplay using the game entity via the physical object. The user may then “download” the stored information to a computing platform such that the most up-to-date version of their game entity can be accessed. In some implementations, information exchange between the physical objects and a computing platform used to access the virtual space may be accomplished via radio-frequency communication (e.g., through an RFID tag within the physical object and an RFID reader attached to the computing platform) and/or other forms of wired and/or wireless communication.

### SUMMARY

One aspect of the disclosure relates to a system for customizing a game entity played by a user in a video game that takes place in a virtual space. Users may purchase physical objects associated with an individual game entity at a retail location (e.g., a store, a shop, a gift shop, a theme park, a market, and/or other considerations). Users may purchase customizations for the associated game entity at the retail location. The customization may affect a parameter value for a parameter of the game entity. The parameter value may be adjusted for the associated game entity in the virtual space independent from gameplay using the game entity in the virtual space and/or video game taking place in the virtual space.

Physical objects may be detected prior to, after, and/or during purchase at the retail location. Physical objects may be detected using a read/write platform that is operatively coupled to or included at a point of purchase computing platform located in the retail location. The read/write platform may include a physical object reader and/or a physical object writer. When a customization is purchased, the read/write platform may be configured to write a parameter value associated with the customization to the physical object for storage on the physical object. The writing of the parameter value may adjust an initial, or default, parameter value, may implement a new parameter for the game entity, and/or may affect the game parameter in other ways. The parameter value may be automatically implemented in the virtual space when the physical object is present at a computing platform used to access the virtual space.

The system may include one or more physical processors configured to execute one or more computer program components. The computer program components may include a detection component, a purchase confirmation component, a storage component, and/or other components.

The detection component may be configured to receive information stored by a physical object from a reader that is operatively coupled to or included at a point of purchase computing platform located at a retail location. The physical object and/or the information stored thereon may be associated with a game entity that is controlled by a user in a virtual space. The appearance of the physical object may represent the game entity.

The purchase confirmation component may be configured to receive information indicating purchase of the physical object and/or a customization for the associated game entity at the point of purchase computing platform. The customization may be associated with a parameter value for a parameter of the game entity.

The storage component may be configured to effectuate storage of the parameter value associated with the customization. Such storage may effectuate implementation of the parameter value for the parameter of the game entity in the virtual space.

These and other objects, features, and characteristics of the present invention, as well as the methods of operation, functions of the related elements of structure, and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The embodiments will be more readily understood in view of the following description when accompanied by the below figures and wherein like reference numerals represent like elements, wherein:

FIG. 1 illustrates an implementation of a system for customizing game entities played in a video game;

FIG. 2 illustrates an implementation of a read/write computing platform used in the system of FIG. 1; and

FIG. 3 illustrates an implementation of a method of customizing game entities played in a video game.

### DETAILED DESCRIPTION

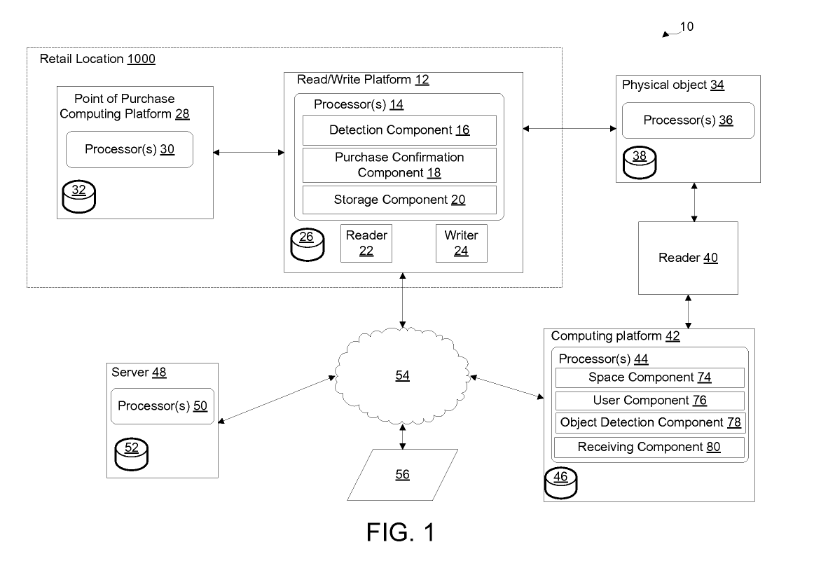

FIG. 1 illustrates a system 10 for customizing a game entity played in a video game. The video game may take place in a virtual space. In some implementations, the video game may be an online game. The video game (e.g., online game) may be hosted by a host server (e.g., server 48) over a network 54, such as the Internet. The video game may be accessed by users via computing platforms, such as computing platform 42.

In some implementations, the video game may be an “offline” version of the online game (e.g., with or without communications with the server 48). The video game may be a console game. The virtual space may be hosted locally on the computing platforms associated with the users. For example, in some implementations, the virtual space may be hosted locally at computing platform 42 associated with one or more user.

User participation in the video game may include controlling game entities in the virtual space. A game entity may refer to a virtual object (or group of objects) present in the virtual space that represents an individual user. A game entity may be a virtual character (e.g., an avatar) and/or other virtual object. A group of game entities may include a group of virtual characters, virtual objects, and/or other considerations.

In some implementations, individual ones of the game entities may be associated with a physical object. The physical objects may store information. The physical objects may store a unique physical object identification and/or other information that uniquely distinguished a physical object from other physical objects (e.g., a serial number, bar code, a name, key, and/or other considerations). The physical objects may store information about the associated game entities and/or virtual space. A given physical object may store information related to one or more parameters of the associated game entity and/or virtual space. A given physical object may store a parameter value of a parameter of the associated game entity.

In some implementations, the physical objects may be physical representations of the game entities associated therewith. A given physical object may be a toy figurine embodying the appearance of an associated game entity, and/or other considerations. In some implementations, physical objects may be detectable by computing platforms via readers that are operatively coupled to or included in the computing platforms (e.g., coupled to or included with one or more processors included in the computing platforms). The readers may facilitate communication and/or information exchange between the physical objects and the computing platforms.

As an illustrative example, system 10 may include physical object 34. The physical object 34 may include one or more processors 36, information storage 38, and/or other components. The physical object 34 may be associated with a first game entity (not shown). The physical object 34 may be a physical representation of the first game entity. For example, the first game entity may be a virtual character representing a pirate (or other character) such that the physical object 34 may be a toy figurine that physically represents the same or similar pirate (or other character). The physical object 34 may be used by a user when accessing the virtual space and/or video game via computing platform 42 and/or other computing platforms.

The physical object 34 may be detectable by read/write platform 12 at the retail location 1000, a reader 40 that is operatively coupled to or included in one or more processors 44 of the computing platform 42, and/or other by other components. The physical object 34 may be detectable by read/write platform 12 (e.g., reader 22) and/or reader 40 based on a signal conveying information associated with and/or stored by physical object 34. For example, the physical object 34 may include a radio-frequency identification (RFID) tag (not shown) and/or other component(s) configured to emit radio-frequency (RF) communications responsive to the physical object 34 being disposed in proximity to the read/write platform 12, the point of purchase computing platform 28, the reader 40, and/or computing platform 42. The RF communications may include information indicative of the physical presence of the physical object 34 (e.g., unique identification information and/or other information) and/or information stored by the physical object 34 (e.g., a parameter value and/or other information). The read/write platform 12 and/or reader 40 may be configured to detect and/or receive the RF communications.

In some implementations, physical objects may be purchased by users at retail locations (e.g., a store, a shop, a gift shop, a theme park, a market, and/or other considerations). Purchase of the physical objects may be facilitated by one or more point of purchase computing platforms present at the retail locations (e.g., a point of sale, a cash register, a checkout stand, a terminal, a kiosk, and/or other considerations). For example, a point of purchase computing platform may include one or more processors configured to execute computer program modules to receive information about a product being purchased (e.g., a name, a price, a barcode, a QR code, input from a teller, produce SKU, and/or other considerations). The point of purchase computing platform may be configured to accept payment information (e.g., from a peripheral card reader, cash received from the purchaser as input from the teller, and/or other considerations). The point of purchase computing platform may be configured to, in response to confirming adequate payment, process the purchase by calculating an amount of change to provide the purchaser (if applicable), updating the retail location's inventory, effectuating printing of a physical receipt, effectuating transmission of a digital receipt, and/or may perform more or less operations. In some implementations, however, a point of purchase computing platform may be completely mechanical in nature.

In some implementations, customizations of the game entities associated with the physical objects may be sold at a retail location. In some implementations, customizations may be associated with customization of a virtual space of which the game entities may be played in. A customization may be associated with, for example, an upgrade for an existing parameter of a game entity (e.g., an upgraded or new parameter value for the parameter), an enhancement of a game entity (e.g., a parameter value for a parameter not usually associated with the game entity in the virtual space), a customization of the virtual space in which a game entity is to be played (e.g., a change in a simulated topography of the virtual space), an introduction of new content into the virtual space in which a game entity is to be played (e.g., a new level, mission, environment, virtual item and/or good, non-player character, and/or other new content), and/or other considerations. Purchase and subsequent storage of a customization may affect a parameter value for an associated game entity in the virtual space, an appearance of a game, virtual space content present in a game (e.g., new content may be introduced, content may be removed), and/or other considerations.

As an illustrative example, in some implementations, if no parameter value for a given parameter of a game entity based on gameplay exists (e.g., prior to any gameplay with the game entity in the virtual space, by virtue of the parameter not normally being associated with the game entity, and/or other considerations), the parameter value associated with the customization may be used to determine, set, and/or otherwise implement a value for the parameter. As such, in some implementations, a parameter value associated with a customization may be a value that is not implemented in the virtual space absent purchasing the customization associated with the parameter value (e.g., “limited edition”, and/or other considerations).

In some implementations, a parameter value of a parameter of a game entity may be predetermined at the start of gameplay using the game entity (e.g., a default, or starting value for the parameter associated with initial purchase of a physical object and/or gameplay with an associated game entity), and/or other considerations. A parameter value of a parameter of a game entity may be determined based on gameplay in the virtual space using the game entity (e.g., the user achieves an upgrade in the virtual space that determines a parameter value for a parameter of the game entity), and/or other considerations. Based on purchasing (and storing) a customization that includes a different (e.g., upgraded, new, and/or other considerations) parameter value for a parameter and implementing the customization thereby adjusting the value of the parameter accordingly (described in more detail herein), the parameter value associated with the purchased customization may override, adjust, adjust, change, and/or otherwise set the value for the parameter in the virtual space (e.g., is implemented independently from gameplay with the associated game entity). In other words, the storage of the parameter value may adjust an initial, or default, parameter value, may implement a new parameter for the game entity, and/or may affect the parameter value in other ways. As an illustrative example, a first user may purchase a first physical object associated with a first game entity they which they control during participation in a virtual space. The first user may purchase a first customization for the associated first game entity. The first customization may be stored. A first new parameter value associated with the first customization may be implemented in the virtual space for the first game entity. The first new parameter value may be implemented immediately upon execution of an instance of the virtual space using the first physical object.

In some implementations, customizations may be provided in retail locations as physical tokens which the users may purchase. A token may include, for example, a card, a coin, a toy, an object, and/or other physical objects that the users purchase at the point of purchase computing platforms similar to any other physical product available for purchase (e.g., includes a bar code, SKU). The physical tokens (not shown) may include information storage that stores one or more parameter values, information related to one or more parameter values, and/or other information. As such, customization information may be obtained directly from the physical tokens via communications with the physical tokens (e.g., the physical tokens are configured for RF and/or wired communications at the point of purchase computing platform and/or other component). For example a first token may be associated with a first customization.

In some implementations, the customization may be provided as a key (e.g., a code, a serial number, a string, a password, and/or other considerations) that the users input at the point of purchase computing platform (e.g., via an input device, such as a keyed touchpad, and/or other considerations). In some implementations, a key may be provided to a user physically (e.g., written on paper) and/or digitally (e.g., stored in a computing platform, and/or other considerations), and/or other considerations. The key may be associated with information related to a customization. For example, a key may be linked to a parameter value, such that input of the key facilitates retrieving the parameter value and/or information related to the parameter value from a storage location (e.g., storage 26, 32, and/or 52, and/or external resource 56). A database that associates keys to customizations (e.g., parameter values or other customization information) may be stored at a storage location for look-up and/or retrieval purposes. In some implementations, a physical token may include a key written and/or otherwise displayed thereon. In some implementations, the customizations may be provided as virtual tokens (e.g., a virtual object), and/or may be a key that is provided to the user on a display of a computing platform. For example, a first key may be associated with a first customization.

In some implementations, parameters of a game entity may include, for example, one or more of an appearance parameter related to the visual appearance of the game entity in the virtual space; a behavior parameter related to the behavior of the game entity in the virtual space; an ability parameter related to a special skill, ability, and/or special weapon available for use by the game entity in the virtual space; a special effects parameter related to special visual effects, attack effects, defensive effects, and/or other effects for the game entity in the virtual space; and/or other parameters related to the game entity in the virtual space. A parameter value of a given parameter may be used to define the given parameter for the game entity in the virtual space. For example a first value may define a first parameter of a first game entity.

In some implementations, the appearance parameter may determine one or more visual attributes of the game entities in the virtual space. For example, the appearance parameter may be related to one or more of a color of the game entity, a height of the game entity, a limb length of the game entity (e.g., if the game entity has limbs), a translucency of the game entity, a surface material (e.g. metallic vs. non-metallic, and/or other considerations) of the game entity, a lighting property of the game entity, and/or other visual attribute that is associated with the game entity in the virtual space.

In some implementations, the parameter value for the appearance parameter may include one or more of a color value defining the color, a height value defining the height, a limb length value defining the limb length, a translucency value defining the translucency, a surface material value defining an attribute of the surface material, a lighting property value defining the lighting property, and/or any other values defining another visual attribute of the game entity related to the appearance parameter.

In some implementations, the parameter value for the appearance parameter may be a qualitative value and/or quantitative value. For example, a qualitative color value may include, but is not limited to, “green”, “red”, “blue”, “yellow”, “bright green”, “dark blue”, “neon red”, and/or other considerations of qualitative expressions that may be used to define a color of a game entity in the virtual space. In some implementations, a color value may be a quantitative value. A quantitative color value may be related to a quality of the color that may be determined by a numerical value, and/or other considerations. For example, a quantitative color value may be a value on a numerical scale from 1 to 10 related to the brightness of the color (or other attribute). For example, a “1” color value may represent a color being the least bright and “10” being the most bright, and/or other considerations. Quantitative color values may be related to other attributes of color that may be determined based on numerical scale such as hue, richness, contrast, and/or other considerations. Quantitative and/or qualitative color values may be considered in other ways.

In some implementations, a qualitative height value defining the height of a game entity may include one or more of “tall”, “short”, “medium tall”, “medium short”, “very tall”, “very short”, and/or other considerations of qualitative expressions that may be used to define a height of a game entity in the virtual space. In some implementations, qualitative height value may be considered relative to a given game entity. For example, a game entity may be a dwarf character that is typically associated with a virtual character of short stature, and/or other considerations. Therefore, terms such as “tall” or “very tall” may be relative to known characteristics of the given game entity. In some implementations, a quantitative height value may include a numerical value that corresponds to one or more units of measurement in the virtual space, and/or other considerations. For example, a quantitative height value may be “10 units” (or other amount), and/or other considerations. Qualitative and/or quantitative height values may be considered in other ways.

In some implementations, qualitative and/or quantitative parameter values for limb length may be considered using units of measurement the same or similar way that height values may be considered as presented herein, and/or other considerations. For example, a qualitative limb length value may be “long”, “short”, and/or other considerations of qualitative expressions that may be used to define a limb length of a game entity in the virtual space. A quantitative limb length value may be, for example, “6 units” (or other amount) and/or other considerations of a numerical value used to determine a limb length. Qualitative and/or quantitative limb length values may be considered in other ways.

In some implementations, a qualitative translucency value defining the translucency of a game entity may include one or more of “translucent”, “not translucent”, “more translucent”, “less translucent”, and/or other considerations of qualitative expressions that may be used to define a translucency of a game entity in the virtual space. In some implementations, a quantitative translucency value may be based on a numerical value, a percentage, a scale, and/or other considerations. For example, a quantitative translucency value may be a value on a numerical scale from 1 to 10 (or other value and/or scale), wherein 1 may be completely opaque (e.g., not translucent) and 10 may be completely transparent, and/or other considerations. Qualitative and/or quantitative translucency values may be considered in other ways.

In some implementations, a qualitative surface material value defining an attribute of a surface material of a surface of a game entity may be a description of the surface material, and/or other considerations. For example, a qualitative surface material value may include one or more of “metal”, “wood”, “plastic”, “shiny”, “rough”, “spikey”, “smooth”, “bumpy”, and/or other considerations of qualitative expressions that may be used to define a surface material of a game entity in the virtual space. Qualitative and/or quantitative surface material values may be considered in other ways.

In some implementations, a qualitative lighting property value defining the lighting property of a game entity in the virtual space may be related to how the game entity is lit and/or emits light in the virtual space, the overall visibility of the game entity in the virtual space, and/or other considerations. For example, a qualitative lighting property may include one or more of “bright”, “brighter”, “less bright”, “dark”, “darker”, “less dark”, “glow”, and/or other considerations of qualitative expressions that may be used to define a lighting property of a game entity in the virtual space. For example, a “glow” may be associated with a visible “aura” surrounding the game entity in the virtual space. In some implementations, a quantitative lighting property value may include a numerical value, percentage, and/or scale that is representative of an amount or degree of lighting of the game entity. For example a quantitative lighting property value may be a value on a numerical scale from 1 to 10, wherein 1 may correspond to the game entity being visualized as a completely black or dark entity and 10 may correspond to the game entity having a brightly glowing visible aura in the virtual space, and/or other considerations. Qualitative and/or quantitative lighting property values may be considered in other ways.

In some implementations, a parameter value may be associated with a behavior parameter. The behavior parameter may determine one or more behavior attributes of a game entity in the virtual space. For example, the behavior parameter may be related to one or more of a speed of a movement of a game entity in the virtual space (e.g. walking, running, and/or other considerations), a hit reaction (e.g., a visible reaction to offensive attacks against the game entity), a collection bonus (e.g., a multiplier and/or other bonus associated with the collection of virtual items and/or currencies, resource harvesting, and/or other collection by the game entity in the virtual space), and/or other behavioral attributes associated with a game entity in the virtual space.

In some implementations, the parameter value for the behavior parameter may include one or more of a speed value defining the speed, a hit reaction value defining a hit reaction, a collection bonus value defining a multiplier and/or other bonus, and/or other value defining another behavioral attribute of the game entity in the virtual space. In some implementations, parameter values for the behavior parameter may be qualitative and/or quantitative values.

In some implementations, a qualitative speed value may include one or more of “fast”, “slow”, “faster”, “slower”, and/or other considerations of qualitative expressions that may be used to define a speed of a game entity in the virtual space, and/or other considerations. In some implementations, a quantitative speed value may include a numerical value, percentage, and/or scale that is representative of the speed of the game entity. For example, a quantitative speed value may be a value on a numerical scale from 1 to 10, where 1 may be the slowest speed and 10 may be the fastest speed, and/or other considerations. In some implementations, a quantitative speed value may include a numerical value that corresponds to one or more units of measurement for speed. For example, the virtual space may be associated with units of measurement related to a distance traveled through the virtual space over unit time and/or other unit of measurement that may be representative of speed of game entities in the virtual space, and/or other considerations. Qualitative and/or quantitative speed values may be considered in other ways.

In some implementations, a hit reaction value may correspond to how a game entity visually responds in the virtual space to offensive “hits” or attacks against the game entity (e.g., from other users and/or from artificial intelligence controlled game entities). For example, a qualitative hit reaction value may correspond to one or more of “react”, “do not react”, “spin”, “fall to the ground”, “get angry”, “get sad”, “grow larger”, “hide”, “run away”, “perform [a defensive block]”, and/or other considerations of qualitative expressions that may be used to define a hit reaction of a game entity in the virtual space. In some implementations, a quantitative hit reaction value may include a numerical value that corresponds to a hit reaction performed by the game entity. For example, a game entity may have a hit reaction where the game entity spins around a number of times in the virtual space and/or performs a different hit reaction. The number of spins may be determined based on a quantitative hit reaction value, e.g., “3” spins (or other amount). Qualitative and/or quantitative speed values may be considered in other ways.

In some implementations, a collection bonus value may be a qualitative or quantitative value defining a multiplier and/or other value associated with the collection of virtual items and/or currencies in the virtual space by the game entity (e.g., resource harvesting) and/or other collection by the game entity in the virtual space. For example, a game entity may harvest virtual resources, such as a virtual food, currency, or other virtual item in the virtual space. Harvesting virtual resources may require a predetermined amount of time to pass per unit resource harvested before the resource can be collected by the game entity and/or stored in a virtual inventory. In some implementations, a quantitative collection bonus value may be a multiplier such as “2×”, “3×”, “4×”, and/or other value that is used to define a speed-up of harvesting time by the multiplier value. In some implementations, a collection bonus value may define the harvesting time for individual resources. For example, a collection bonus value may define that the harvest of “virtual corn” (or other virtual item) is “5 minutes” (or other value). Qualitative and/or quantitative collection bonus values may be considered in other ways.

In some implementations, a parameter value may be associated with an ability parameter. An ability parameter may be related to a special skill or ability and/or special weapon available for use by the game entity in the virtual space.

In some implementations, a parameter value for the ability parameter may include one or more of a skill value defining a special or ability of the game entity, a weapon value defining a special weapon available for use by the game entity in the virtual space, and/or other considerations. The parameter value for the ability parameter may be a qualitative or quantitative value.

In some implementations, a skill value may be an expression related to a skill or ability of the game entity in the virtual space. For example, a skill value may include “super kick/punch”, “high jump”, “turbo speed”, and/or other considerations of qualitative expressions that may be used to define a special skill or ability of a game entity in the virtual space. Skill values may be quantitative values. Qualitative and/or quantitative skill values may be considered in other ways.

In some implementations, a weapon value may be an expression related to a virtual weapon that is to be made available (e.g., unlocked or provided in a virtual inventory associated with the game entity) to the game entity in the virtual space. For example, a weapon value may include “super bazooka”, “enchanted sword”, and/or other considerations of qualitative expressions that may be used to define a special weapon that is available to the game entity in the virtual space. Weapon values may be quantitative values. Qualitative and/or quantitative weapon values may be considered in other ways.

In some implementations, a parameter value may be associated with a special effects parameter. A special effects parameter may be related to special visual effects, attack effects, defensive effects, and/or other effects associated with a game entity in the virtual space.

In some implementations, the parameter value for the special effects parameter may include one or more of a visual effect value defining one or more special visual effect, an attack effect value defining one or more attack effects, a defense effect value defining one or more defensive effects, and/or other considerations.

In some implementations, the visual effect value may be an expression that defines a special visual effect in the virtual space for the game entity in the virtual space. A special visual effect may be related to a visual effect during the spawning of the game entity in the virtual space, a visual effect during the death of the game entity, and/or other considerations of special visual effects.

In some implementations, the attack effect value may be an expression that defines a special visual effect in the virtual space during offensive attacks by the game entity.

In some implementations, the defensive effect value may be an expression that defines a special visual effect in the virtual space during defensive moves, such as blocks, by the game entity in the virtual space.

In some implementations, the parameter values associated with the customizations may be values that are normally not associated with the associated game entities and/or are values that may not be accessible through gameplay with the associated game entities in the virtual space. For example, the first game entity may normally be associated with a color value (e.g., red or other color) in the executed instance of the virtual space. A given customization may be associated with a color value for a “limited edition” version of the first game entity (e.g. green or other color). By virtue of purchase of the customization and implementation thereof, the appearance parameter (e.g., color and/or other attribute) of the first game entity may be set to the custom color value.

In some implementations, customizations may include introduction of new virtual space content in the virtual space. Herein, the term “content” may refer to one or more of virtual objects that may be expressed within the virtual space, virtual environments and/or spaces that may be accessible to game entities in the virtual space and/or otherwise expressed within the virtual space (e.g., a social space such as a chat room and/or other social space; a gameplay space such as a combat arena, race track, puzzle platform or other gameplay pace; and/or other environment), an aspect of gameplay (e.g., a mission, a task, an objective, and/or other gameplay aspect), a non-player character (e.g., a boss, an enemy, a friend, a pet, and/or other non-player controlled object), and/or other considerations. Virtual objects may include virtual items and/or virtual goods that may be usable within the virtual space and/or otherwise may be expressed within the virtual space. Virtual items and/or goods may include one or more of a structure (e.g., a building, a house, a cave, an igloo, and/or other considerations), clothing (e.g., shirt, hat, pants, etc.), a decoration, an accessory, a virtual resource, a structural element, a vehicle, a food, a currency, a reward, a bonus, health, a potion, an enhancement, a mount, a power-up, a speed-up, and/or other considerations. For example, a first customization may be associated with introduction of first new content into the virtual space.

In some implementations, virtual space content that may be introduced into a virtual space may be specifically related to a game entity and/or physical object purchased by a user. In some implementations, new virtual space content, a game entity, and/or a physical object may be specifically by a theme. A theme may include one or more of color, brand, type, and/or other considerations. For example, first new content and a first game entity (or first physical object associated with the first game entity) may be associated by a first theme. By way of non-limiting example, a “pirate” themed physical object may be associated with “pirate” themed customizations to be implemented in the virtual space (e.g., a pirate themed virtual item, non-player character, environment, and/or other considerations).

In some implementations, a physical object associated with a game entity intended for customization may be detected at the point of purchase computing platform when the physical object and/or customization is being purchased by a user. The detection of the physical object may be facilitated by a physical object reader/writer platform that is operatively coupled to or included with the point of purchase computing platform. The point of purchase computing platform may be configured to confirm purchase of the physical object and/or the customization for the associated game entity. The read/write platform may be configured to, in response to purchase configuration of one or both of the physical object and customization by the point of purchase computing platform, effectuate storage of the parameter value or other information associated with the customization. The storage may be effectuated by virtue of communicating the parameter value or other information associated with the customization to the physical object for storage thereon and/or to a server associated with the virtual space (e.g., a server 48).

As an illustrative example in FIG. 1, the system 10 may include a point of purchase computing platform 28 located at retail location 1000. The point of purchase computing platform 28 may include one or more processors 30, storage 32, and/or other components. The point of purchase computing platform 28 may include a read/write platform 12 operatively coupled to or included at point of purchase computing platform 28. For example, point of purchase computing platform 28 and/or read/write platform 12 may be configured for wired communications (e.g., including one or more ports configured to receive communication wires), wireless communications (e.g., Bluetooth, wi-fi, near field communication, FireWire, Infrared, 3DS reader, and/or other radio frequency communications), and/or may employ other communication scheme and/or protocols.

The read/write platform 12 may include one or more processors 14, a reader 22, a writer 24, information storage 26 (e.g., electronic storage), and/or other components. In some implementations, the read/write platform 12 may be provided as a base, a stand, a kiosk, a scanner, a display, a platform, and/or other physical structure. In some implementations, the read/write platform 12 may be a physical structure that a user may place physical object 34 on top of, next to, and/or otherwise in proximity of the read/write platform 12 (e.g., within the detectable range of reader 22). In some implementations, read/write platform 12 may be physically separate from the point of purchase computing platform 28. In some implementations, the read/write platform 12 may be at least partially integrated with the point of purchase computing platform 28. The read/write platform 12 may be provided in the retail location 1000 in other ways.

The reader 22 and/or writer 24 included in the read/write platform 12 may be configured for wireless radio frequency (RF) communications with physical object 34 and/or other physical objects, wired communications, and/or may employ other communication schemes and/or protocols. For example, the reader 22 and/or writer 24 may be configured for wireless Bluetooth communications, near field communications (NFC), radio frequency identification (RFID) tag communications, wired communications using USB or other wires (e.g., using one or more ports configured to receive a plug), parallel ports, FireWire, Infrared, 3DS reader, and/or other considerations. In some implementations, reader 22 and/or writer 24 may comprise a radio frequency identification (RFID) tag reader and/or writer. For example, reader 22 may comprise one or more components of a passive reader active tag (PRAT) system, active reader passive tag (ARPT) system, active reader active tag (ARAT) system, and/or other considerations of components which may receive RF signals. In some implementations, the writer 24 may comprise one or more components that are configured to send (e.g., write) RF signals. In some implementations, reader 22 and/or writer 24 may be provided as a single component, such as a combined RFID tag reader/writer, configured for both sending and receiving RF signals. The reader 22 and/or writer 24 may be considered in other ways.

The processors 14 may be configured to execute one or more computer program components to facilitate receiving information from physical objects detected by reader 22, confirming purchase of a customization and/or physical object, effectuating storage of information included in the customization, and/or performing more or less operations. The computer program components may include a detection component 16, a purchase confirmation component 18, a storage component 20, and/or other components.

The detection component 16 may be configured to receive information stored by physical object 34 and/or other physical objects from reader 22 operatively coupled to, or included at, point of purchase computing platform 28 located at retail location 1000. The reader 22 may obtain information stored on one or more physical objects, such as identification information of the physical objects, information about one or more game entities that are associated with the physical objects, and/or any other information stored on and/or associated with the physical objects.

The received information may include identification information indicating presence of one or more physical objects detected by reader 22. The identification information may differ from other information stored by the physical objects (e.g. parameter values) in that the identification information may not be related to an implementation of the game entities associated with physical objects in the virtual space, but may merely be information used to identify the physical objects for indicating presence (e.g., a bar code, tag ID, a serial number, and/or other considerations).

In some implementations, the detection component 16 may be configured to receive the identification information stored on the physical object(s) from reader 22 at a sampling rate preconfigured by the provider developer, manufacturer, and/or any other entities related to the system 10. Simultaneously or alternatively, the detection component 16 may be configured to receive such information from reader 22 dynamically as information is being pushed to the read/write platform 12 by reader 22.

In some implementations, the received identification information from reader 22 by the detection component 16 may comprise identification information about a physical object whose presence being detected by reader 22, for example, such as one or more tag IDs associated with the physical object, a name of the physical object, a name of an associated game entity, a description of an associated game entity, a bar code associated with the physical object, a serial number, and/or any other identification information about the physical object present on reader 22.

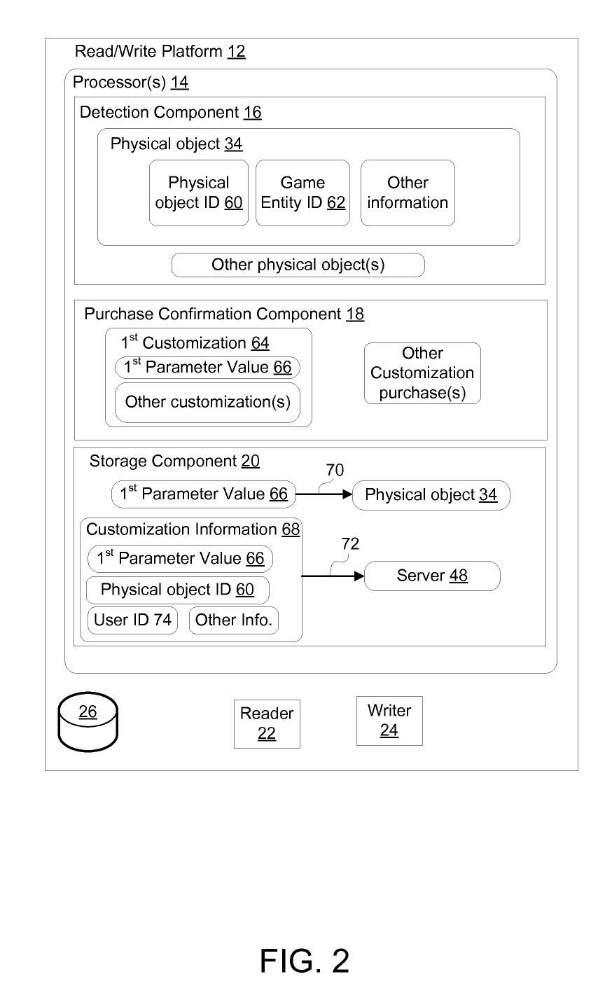

As an illustrative example in FIG. 2, the detection component 16 may be configured to receive information stored by physical object 34. The information stored by physical object 34 may include a physical object identification 60, a game entity identification 62 (e.g., for the first game entity), and/or other information.

Returning to FIG. 1, the purchase confirmation component 18 may be configured to receive information indicating purchase of physical object 34 and/or other physical objects and/or one or more customizations (not shown in FIG. 1) for the first game entity and/or other game entity at point of purchase computing platform 12. In some implementations, the information indicating purchase of physical object 34 and/or a customization may be received from point of purchase computing platform 28, teller input, and/or from other sources. For example, upon completion of purchase of physical object 34 and/or a customization, point of purchase computing platform 28 may be configured to communicate information to read/write platform 12 indicating the successful completion of the purchase(s). In some implementations, upon completion of purchase of physical object 34 and/or the customization, the teller and/or user may input into read/write platform 12 (and/or point of purchase computing platform 28) that the purchase has been completed (e.g., via a user interface of read/write platform 12 and/or other considerations). The teller and/or user may input a key or other information that is specific to a purchase.

As an illustrative example in FIG. 2, the purchase confirmation component 18 may be configured to receive information indicating purchase of a first customization 64 for the first game entity associated with physical object 34. The first customization 64 may be associated with a first parameter value 66 for a first parameter for the first game entity in the virtual space, and/or may be associated with other customization information (e.g., new virtual space content).

Returning to FIG. 1, the storage component 20 may be configured to effectuate storage of a parameter value (and/or other customization information) associated with a purchased customization. Such storage may effectuate implementation of the parameter value for the parameter of a game entity (or other customization) in the virtual space. In some implementations, effectuating storage of the parameter value may comprise effectuating transmission (e.g., writing) of the parameter value and/or other customization information by a writer 24 to physical object 34 for storage on information storage 38 of physical object 34. Implementation of the parameter value and/or other customization information may be effectuated by virtue of physical object 34 being detected at computing platform 42 used to execute an instance of the virtual space (presented in more detail herein). The first parameter of the first game entity may automatically reflect the stored first parameter value in the executed instance of the virtual space, for example, right at the start of gameplay using the first game entity.

In some implementations, effectuating storage of the parameter value and/or other customization information may include transmitting customization information (e.g., the parameter value, the unique identification of the physical object 34, new content, information used to look up new content, and/or other information) to server 48 associated with the virtual space. The implementation of the parameter value may be effectuated by virtue of server 48 receiving information indicating that physical object 34 is present at computing platform 42 used by a user to participate in an instance of the virtual space using the first game entity. For example, computing platform 42 may receive the unique identification of physical object 34 when it is present at computing platform 42, computing platform 42 may communicate the unique identification to server 48, and server 48 may perform a lookup of the unique identification to see if it is associated with customization information from a purchased customization. This feature may be employed as a type of verification of whether physical object 34 is associated with a purchase of a customization or not. This may be carried out independently or in combination with storage of the customization information on physical object 34.

As an illustrative example in FIG. 2, the storage component 20 may be configured to effectuate storage of the first parameter value 66 by effectuating transmission 70 of the first parameter value 66 by writer 24 to physical object 34 for storage on information storage 38 (not shown in FIG. 2) of physical object 34. In some implementations, the storage component 20 may be configured such that effectuating storage of the first parameter value 66 includes transmitting 72 customization information 68 (e.g., including the first parameter value 66, the physical object identification 60 of the physical object 34, and/or other information) to server 48. In some implementations, the storage component 20 may be configured to effectuate storage of information corresponding to first new content (not shown) associated with a second customization. The information corresponding to the first new content may include information that defines the first new content (e.g., source code), information identifying the first new content, wherein the information identifying the first new content may be used to look-up information that defines the first new content (e.g., via server) 48), and/or other considerations.

In FIG. 1, in some implementations, providing the virtual space may include hosting the virtual space on computing platforms. The virtual space may be hosted on computing platform 42. Briefly, although the following description is directed towards computing platform 42, it is to be understood that the computing platforms in general may be similarly configured and/or may include the same or similar components in order to carry out the same or similar functions and/or features attributed to computing platform 42 as presented herein.

The computing platform 42 may comprise, for example, a client, a cellular telephone, a smartphone, a laptop, a tablet computer, a desktop computer, a television set-top box, smart TV, a gaming console, and/or other device suitable for the intended purposes as described herein, and/or other considerations.

In some implementations, computing platform 42 may be a gaming console and/or other type of computing platform. Computing platform 42 may be configured to execute an instance of the virtual space and/or video game taking place in the virtual space by using information stored by and/or local to computing platform 42 (e.g., a game cartridge, game disk, memory card/stick, USB memory stick, electronic storage, and/or other considerations) and/or other information. In some implementations, computing platform 42 may be configured to execute an instance of the virtual space and/or video game using information received from server 48. In some implementations, computing platform 42 may be configured to communicate with server 48, for example, over network 54.

Computing platform 42 may include one or more processors 44 configured to execute one or more computer components for implementing the instance of the virtual space and/or a video game taking place within the virtual space and to facilitate the participation of one or more users in the virtual space and/or video game. The computer program components of computing platform 42 may include one or more of a space component 74, a user component 76, an object detection component 78, a receiving component 80, and/or other components.

In some implementations, some or all of the functionality of computing platform 42 may be attributed to server 48. In such implementations, providing the virtual space may include hosting the virtual space over the network 54. The server 48 may include one or more processors 50 configured to execute the one or more computer components for implementing an instance of the virtual space and/or a video game taking place within the virtual space and to facilitate the participation of one or more users in the virtual space and/or video game (e.g., online game). Processors 50 may be configured to execute the same or similar components as presented for computing platform 42, and/or other considerations. The users may access server 48 and/or the virtual space via computing platforms. Server 48 may include information storage 52.

In some implementations of online gameplay and/or other gameplay, server 48 may be configured to determine state of the virtual space. The state may then be communicated (e.g., via streaming visual data, via object/position data, and/or other state information) from server 48 to computing platform 42 and/or other computing platforms for presentation to user 26 and/or other users. An instance of the virtual space may comprise a simulated space that is accessible by users via a client (e.g., computing platform 42 and/or other computing platforms) that presents the views of the virtual space to the users. Server 48 may be attributed with more or less functionality described herein for computing platform 42 in order for server 48 to execute an instance of the virtual space and/or video game as presented herein.

Referring back to computing platform 42, the space component 74 may be configured to execute and implement an instance of the virtual space. The instance of the virtual space may be executed by the computer components to determine state of the virtual space. The state determined and presented by computing platform 42 may correspond to a location in the virtual space (e.g., location in the game). The view described by the state may correspond, for example, to the location from which the view is taken, the location the view depicts, and/or other locations; a zoom ratio; a dimensionality of objects; a point-of-view; and/or view parameters of the view. One or more of the view parameters may be selectable by a user of computing platform 42.

An instance of the virtual space may comprise a simulated space that is accessible by users via the computing platforms (e.g., computing platform 42) that presents the views of the virtual space to the users. The simulated space may have a topography, express ongoing real-time interaction by one or more users, and/or include one or more objects positioned within the topography that are capable of locomotion within the topography. In some instances, the topography may be a 2-dimensional topography. In other instances, the topography may be a 3-dimensional topography. The topography may include dimensions of the space and/or surface features of a surface or objects that are “native” to the space. In some instances, the topography may describe a surface (e.g., a ground surface) that runs through at least a substantial portion of the space (e.g., comprising at least part of a virtual terrain). In some instances, the topography may describe a volume with one or more bodies positioned therein (e.g., a simulation of gravity-deprived space with one or more celestial bodies positioned therein). An instance executed by the computer components may be synchronous, asynchronous, and/or semi-synchronous.

The above description of the manner in which state of the virtual space is determined by space component 74 is not intended to be limiting. The space component 74 may be configured to express the virtual space in a more limited, or richer, manner. For example, views determined for the virtual space representing the state of the instance of the virtual space may be selected from a limited set of graphics depicting an event in a given place within the virtual space. The views may include additional content (e.g., text, audio, pre-stored video content, and/or other content) that describes particulars of the current state of the place, beyond the relatively generic graphics. For example, a view may include a generic battle graphic with a textual description of the opponents to be confronted. Other expressions of individual places within the virtual space are contemplated.

Within the instance(s) of the virtual space executed by space component 74, one or more users of computing platform 42 may control game entities, groups of game entities, simulated physical phenomena (e.g., wind, rain, earthquakes, and/or other phenomena), and/or other elements within the virtual space to interact with the virtual space and/or other users. The game entities may include virtual characters, such as avatars, group entities, and/or other considerations. A given game entity may be controlled by a user of computing platform 42 with which it is associated. The user-controlled element(s) may move through and interact with the virtual space (e.g., non-user characters in the virtual space, other objects in the virtual space). The user-controlled elements controlled by and/or associated with one or more users of computing platform 42 may be created and/or customized by the one or more users, based on information received by computing platform 42 (e.g., from server 48 and/or reader 40), and/or may be based on other information. One or more users of computing platform 42 may have an “inventory” of virtual items, game entities, and/or currency that the one or more users of computing platform 42 can use (e.g., by manipulation of a virtual character or other user-controlled element, and/or other items) within the virtual space.

The one or more users of computing platform 42 may participate in the instance of the virtual space by controlling one or more of the available user-controlled game entities in the virtual space. Control may be exercised through control inputs such as entry, selection, and/or commands input by the one or more users of computing platform 42 and/or other computing platforms. Other users of the virtual space may interact with the one or more users of computing platform 42 and/or other users through communications exchanged within the virtual space. Such communications may include one or more of textual chat, instant messages, private messages, voice communications, and/or other communications. Communications may be received and entered by the users via their respective computing platforms. Communications may be routed to and from the appropriate users through network 54 and/or through communications which are external to the system 10 (e.g., text messaging services associated with the users).

The instance of the virtual space and/or the online game that takes place therein may be persistent. That is, the virtual space and/or the game may continue on whether or not individual players are currently logged in and/or participating in the game. A player that logs out of the virtual space and then logs back in some time later may find the virtual space has been changed through the interactions of other players with the virtual space during the time the player was logged out. These changes may include changes to the simulated physical space, changes in the user's inventory, changes in other user's inventories, changes experienced by non-player characters, changes to the virtual items available for use in the online game, and/or other changes.

Within the instance of the video game and/or virtual space executed by the space component 74, information may be implemented in the video game and/or virtual space responsive to presence of physical objects (e.g., physical object 34) on and/or near reader 40 that is operative coupled to or included in the computing platform 42. Such information may be provided in the instance of the virtual space by implementing the information associated with the physical objects when the physical objects are present on reader 40.

For example, a game entity may not be provided in the instance of the virtual space when a corresponding physical object is not present on reader 40, but will be provided in the instance of virtual space when the physical object is present on reader 40. For such selective implementation of the instance of the virtual space, the space component 74 may be configured to implement the information associated with the game entity responsive to the physical object being present on reader 40. For example, the space component 74 may be configured to implement a parameter value for a parameter of the first game entity associated with physical object 34 into the instance of the virtual space by virtue of the physical object 34 storing the parameter value, and responsive to physical object 34 being present on reader 40.

In FIG. 1, the user component 76 may be configured to access and/or manage one or more user profiles, user information, and/or user accounts associated with users of the virtual space and/or computing platform 42. The one or more user profiles and/or user information may include information stored locally to computing platform 42, by server 48, one or more other computing platforms, and/or other storage locations. The user profiles may include, for example, information identifying users (e.g., a username or handle, a number, an identifier, and/or other identifying information) within the virtual space, security login information (e.g., a login code or password), virtual space account information, subscription information, virtual (or real) currency account information (e.g., related to currency held in credit for a user), control input information (e.g., a history of control inputs provided by the user), virtual inventory information (e.g., virtual inventories associated with the users that include one or more virtual items available for the users in the virtual space and/or a game entity available to the user for use in the virtual space), relationship information (e.g., information related to relationships between users in the virtual space), virtual space usage information (e.g., a log-in history indicating the frequency and/or amount of times the user logs-in to the user accounts), demographic information associated with users, interaction history among users in the virtual space, information stated by users, browsing history of users, a computing platform identification associated with a user, a phone number associated with a user, and/or other information related to users.

The object detection component 78 may be configured to receive identification information indicating presence of one or more physical objects detected by reader 40. The identification information may differ from other information stored by the physical objects (e.g. parameter values) in that the identification information may not be related to an implementation of the game entities associated with physical objects in the virtual space, but may merely be information used to identify the physical objects for indicating presence (e.g., a bar code, tag ID, a serial number, and/or other considerations). The reader 40 may be operatively included in or operatively coupled to computing platform 42 (e.g., with one or more processor 44) via any suitable wired or wireless communication through, such as but not limited to, universal serial bus (USB), Bluetooth, parallel ports, FireWire, Infrared, 3DS reader, and/or any other suitable wired or wireless communication. The reader 40 may obtain information stored on one or more physical objects, such as identification information of the physical objects, information about one or more game entities that are associated with the physical objects, and/or any other information stored on the physical objects. The reader 40 may obtain such information from the physical objects through technologies such as RFID, NFC, Bluetooth, and/or any other communication technologies suitable for reading information stored on a physical object by reader 40. The reader 40 may be the same or similar to reader 22.

In some implementations, the object detection component 78 may be configured to receive the identification information stored on the physical object(s) from reader 40 at a sampling rate preconfigured by the provider developer, manufacturer, and/or any other entities related to the system 10. Simultaneously or alternatively, the object detection component 78 may be configured to receive such information from reader 40 dynamically as information is being pushed to the computing platform 42 by reader 40.

In some implementations, the received identification information from reader 40 by the object detection component 78 may comprise identification information about a physical object whose presence is being detected by the reader 40, for example, such as, one or more tag IDs associated with the physical object, a name of the physical object, a bar code associated with the physical object, a serial number, and/or any other identification information about the physical object present on reader 40.

In some implementations, the receiving component 80 may be configured to receive information related to game entities stored by the physical objects from reader 40 that detects the physical objects. In some implementations, the receiving component 80 may be configured to receive the information stored on the physical object(s) from reader 40 at a sampling rate preconfigured by the provider developer, manufacturer, and/or any other entities related to the system 10.

The information received by receiving component 80 may include information about game entities that are associated with the physical objects and/or the users of the physical objects. In some implementations, the received information may affect a parameter value for a parameter of a game entity associated with a given physical object and/or a purchased customization as presented above. For example, receiving component 80 may receive the first parameter value for first parameter of the first game entity associated with physical object 34 based on a user of physical object 34 purchasing a customization (not shown) at the retail location 1000 and the parameter value being stored on physical object 34. The first parameter value stored by physical object 34 may be used to set the value of the parameter for the first game entity in the virtual space. The first parameter value stored by physical object 34 may be used to set the value of the first parameter in the virtual space independently from gameplay using the associated game entity.

In some implementations, the receiving component 80 may receive first new content and/or information corresponding to the first new content to be introduced into the virtual space. The first new content may be associated with physical object 34 based on a user of physical object 34 purchasing a customization at the retail location 1000.

In some implementations, the space component 74 may be configured to implement the received information in the instance of the video game. For example, the space component 74 may be configured to implement the received first parameter value stored by physical object 34. Implementing the first parameter value may include defining the first parameter by the first parameter value for the first game entity in the virtual space, and/or other considerations. In some implementations, space component 74 may be configured to implement the first new content in the virtual space.

The server 48, computing platforms (e.g., computing platform 42), read/write platform 12, and/or external resources 56 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server 48, computing platform 42, read/write platform 12, and/or external resources 56 may be operatively linked via some other communication media.

The external resources 56 may include sources of information that are outside of system 10, external entities participating with system 10, and/or other resources. In some implementations, some or all of the functionality attributed herein to external resources 56 may be provided by resources included in system 10.

Computing platform 42 may include information storage 46, one or more processors 44, and/or other components. Computing platform 42 may include communication lines, or ports to enable the exchange of information with a network, a server, and/or other computing platforms. Illustration of computing platform 42 in FIG. 1 is not intended to be limiting. Computing platform 42 may include a plurality of hardware, software, and/or firmware components operating together to provide the functionality attributed herein to computing platform 42.

Server 48 may include storage 52, one or more processors 50, and/or other components. Server 48 may include communication lines, or ports to enable the exchange of information with a network and/or other computing platforms. Illustration of server 48 in FIG. 1 is not intended to be limiting. The server 48 may include a plurality of hardware, software, and/or firmware components operating together to provide the functionality attributed herein to server 48. For example, server 48 may be implemented by a cloud of computing platforms operating together as server 48.

Information storage (e.g., 26, 32, 38, 46, and/or 52) may comprise electronic storage media that electronically stores information. The electronic storage media of the information storage may include one or both of storage that is provided integrally (i.e., substantially non-removable) with the respective device and/or removable storage that is removably connectable to the respective device. Removable storage may include, for example, a port or a drive. A port may include a USB port, a firewire port, and/or other port. A drive may include a disk drive and/or other drive. Information storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The information storage may include one or more virtual storage resources (e.g., cloud storage, a virtual private network, and/or other virtual storage resources). Information storage may store files, software algorithms, information determined by processor(s), and/or other information that enables the respective devices to function as described herein.

Processor(s) (e.g., 14, 30, 36, 44, and/or 50) are configured to provide information processing capabilities in the respective device. As such, processors may include one or more of a digital processor, an analog processor, a digital circuit designed to process information, an analog circuit designed to process information, a state machine, and/or other mechanisms for electronically processing information. Although the processors are shown in FIG. 1 as single respective entities within the respective devices, this is for illustrative purposes only. In some implementations, the processors may include one or more processing units. These processing units may be physically located within the same device or may represent processing functionality of a plurality of devices operating in coordination.

For example, processor 14 may be configured to execute components 16, 18, and/or 20. Processor 14 may be configured to execute components 16, 18, and/or 20 by software; hardware; firmware; some combination of software, hardware, and/or firmware; and/or other mechanisms for configuring processing capabilities on processor 14.

It should be appreciated that although components 16, 18, and/or 20 are illustrated in FIG. 1 as being co-located within a single processing unit, in implementations in which processor 14 includes multiple processing units, one or more of components 16, 18, and/or 20 may be located remotely from the other components. The description of the functionality provided by the different components 16, 18, and/or 20 described above is for illustrative purposes, and is not intended to be limiting, as any of components 16, 18, and/or 20 may provide more or less functionality than is described. For example, one or more of components 16, 18, and/or 20 may be eliminated, and some or all of its functionality may be provided by other ones of components 16, 18, 20, and/or other components. As another example, processor 14 may be configured to execute one or more additional components that may perform some or all of the functionality attributed to one or more of components 16, 18, and/or 20.

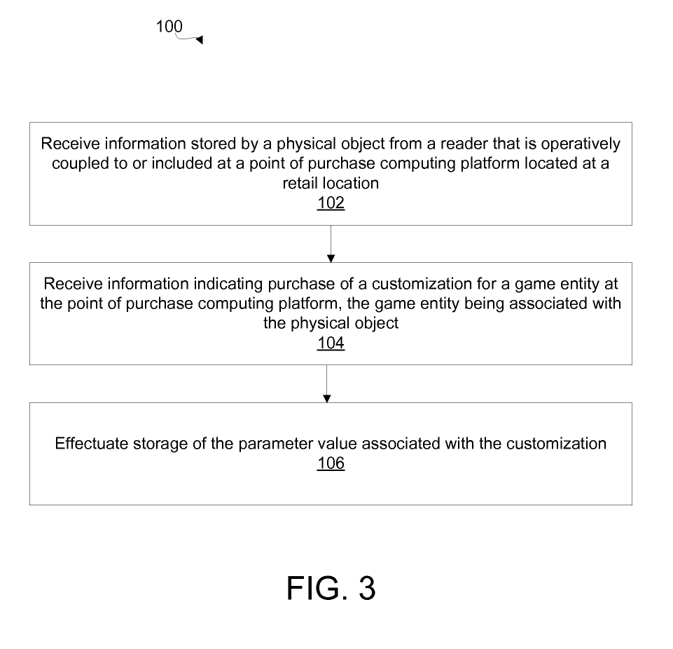

FIG. 3 illustrates an example of a method 100 of customizing game entities in a video game. The operations of method 100 presented below are intended to be illustrative. In some embodiments, method 100 may be accomplished with one or more additional operations not described, and/or without one or more of the operations discussed. Additionally, the order in which the operations of method 100 are illustrated in FIG. 3 and described below is not intended to be limiting.

In some embodiments, method 100 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 100 in response to instructions stored electronically on an electronic storage medium. The one or more processing devices may include one or more devices configured through hardware, firmware, and/or software to be specifically designed for execution of one or more of the operations of method 100.

At operation 102, information stored by a physical object may be received from a reader operatively coupled to or included at a point of purchase computing platform located at a retail location. The physical object and/or the information stored thereon may be associated with a game entity that is controlled by a user in a video game that takes place in a virtual space. The appearance of the physical object may represent the game entity. In some implementations, operation 102 may be performed by a detection component the same as or similar to detection component 16 (shown in FIG. 1 and described herein).

At operation 104, information indicates purchase of a customization for the game entity at the point of purchase computing platform may be received. The customization may be associated with a parameter value for a parameter of the game entity in the virtual space, and/or other customization. In some implementations, operation 104 may be performed by a purchase confirmation component the same as or similar to purchase confirmation component 18 (shown in FIG. 1 and described herein).

At operation 106, storage of the parameter value (or other customization) associated with the customization may be effectuated. Such storage may effectuate implementation of the parameter value for the parameter of the game entity and/or other customization in the virtual space. In some implementations, operation 106 may be performed by a storage component the same as or similar to storage component 20 (shown in FIG. 1 and described herein).

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system for customizing game entities played in a video game, the system comprising:
one or more physical processors configured by computer-readable instructions to:
receive information stored by a physical object from a reader operatively coupled to or included at a point of purchase computing platform located at a retail location, the physical object and the information stored thereon being associated with a game entity that is controlled by a user in a video game that takes place in a virtual space, wherein the appearance of the physical object represents the game entity;
receive information indicating purchase of a customization for the game entity at the point of purchase computing platform, the customization being associated with a parameter value for a parameter of the game entity in the virtual space; and
effectuate storage of the parameter value associated with the customization, such storage effectuating implementation of the parameter value for the parameter of the game entity in the virtual space.

2. The system of claim 1, wherein the one or more physical processors are configured by computer-readable instructions such that effectuating storage of the parameter value comprises effectuating wireless transmission of the parameter value by a writer that is operatively coupled to or included at the point of purchase computing platform to the physical object.

3. The system of claim 2, wherein the one or more physical processors are configured by computer-readable instructions such that the implementation of the parameter value is effectuated by virtue of the physical object being detected at a computing platform used to execute an instance of the virtual space, wherein the parameter of the associated game entity reflects the stored parameter value in the executed instance of the virtual space.

4. The system of claim 1, wherein the one or more physical processors are configured by computer-readable instructions such that effectuating storage of the parameter value includes transmitting customization information to a server associated with the virtual space.

5. The system of claim 4, wherein the one or more physical processors are configured by computer-readable instructions such that the customization information includes the parameter value and/or a unique identification of the physical object.

6. The system of claim 4, wherein the one or more physical processors are configured by computer-readable instructions such that the implementation of the parameter value is effectuated by virtue of the server receiving information, indicating that the physical object is present at a computing platform being used by a user to participate in an instance of the virtual space.

7. The system of claim 1, wherein the one or more physical processors are configured by computer-readable instructions such that the parameter value associated with the customization is implemented for the game entity in the virtual space independent of gameplay using the game entity in the virtual space.

8. The system of claim 1, wherein the one or more physical processors are configured by computer-readable instructions such that the parameter of the game entity includes one or more of an appearance parameter related to the visual appearance of the game entity in the virtual space, a behavior parameter related to the behavior of the game entity in the virtual space, an ability parameter related to a special skill or ability of the game entity and/or special weapon available for use by the game entity in the virtual space, and a special effects parameter related to special visual effects, attack effects, and/or defensive effects for game entity in the virtual space.

9. The system of claim 1, wherein the one or more physical processors are configured by computer-readable instructions such that the customization is associated with a physical token that is purchased at the retail location using the point of purchase computing platform.

10. The system of claim 1, wherein the one or more processors are included in a read/write platform that is operatively coupled to or included at the point of purchase computing platform at the retail location.

11. A method of customizing game entities played in a video game, the method being implemented in a computer system including one or more physical processors and storage media storing machine-readable instructions, the method comprising:
receiving information stored by a physical object from a reader operatively coupled to or included at a point of purchase computing platform located at a retail location, the physical object and the information stored thereon being associated with a game entity that is controlled by a user in a video game that takes place in a virtual space, wherein the appearance of the physical object represents the game entity;
receiving information indicating purchase of a customization for the game entity at the point of purchase computing platform, the customization being associated with a parameter value for a parameter of the game entity in the virtual space; and
effectuating storage of the parameter value associated with the customization, such storage effectuating implementation of the parameter value for the parameter of the game entity in the virtual space.

12. The method of claim 11, wherein effectuating storage of the parameter value comprises effectuating wireless transmission of the parameter value by a writer that is operatively coupled to or included at the point of purchase computing platform to the physical object.

13. The method of claim 12, wherein the implementation of the parameter value is effectuated by virtue of the physical object being detected at a computing platform used to execute an instance of the virtual space, wherein the parameter of the associated game entity reflects the stored parameter value in the executed instance of the virtual space.

14. The method of claim 11, wherein effectuating storage of the parameter value includes transmitting customization information to a server associated with the virtual space.

15. The method of claim 14, wherein the customization information includes the parameter value and/or a unique identification of the physical object.

16. The method of claim 14, wherein the implementation of the parameter value is effectuated by virtue of the server receiving information, indicating that the physical object is present at a computing platform being used by a user to participate in an instance of the virtual space.

17. The method of claim 11, wherein the parameter value associated with the customization is implemented for the game entity in the virtual space independent of gameplay using the game entity in the virtual space.

18. The method of claim 11, wherein the parameter of the game entity includes one or more of an appearance parameter related to the visual appearance of the game entity in the virtual space, a behavior parameter related to the behavior of the game entity in the virtual space, an ability parameter related to a special skill or ability of the game entity and/or special weapon available for use by the game entity in the virtual space, and a special effects parameter related to special visual effects, attack effects, and/or defensive effects for game entity in the virtual space.

19. The method of claim 11, wherein the customization is associated with a physical token that is purchased at the retail location using the point of purchase computing platform.

20. The method of claim 11, wherein the computer system is a read/write platform that is operatively coupled to or included at the point of purchase computing platform at the retail location.

21. The system of claim 1, wherein the one or more physical processors are configured by computer-readable instructions to:
receive information indicating purchase of a second customization at the point of purchase computing platform, the second customization being associated with new content of the virtual space; and
effectuate storage of information corresponding to the new content associated with the second customization, such storage effectuating implementation of the new content in the virtual space.

22. The method of claim 11, additionally comprising:
receiving information indicating purchase of a second customization at the point of purchase computing platform, the second customization being associated with new content of the virtual space; and
effectuating storage of information corresponding to the new content associated with the second customization, such storage effectuating implementation of the new content in the virtual space.

23. A system for customizing a video game, the system comprising:
one or more physical processors configured by computer-readable instructions to:
receive information stored by a physical object from a reader operatively coupled to or included at a point of purchase computing platform located at a retail location, the physical object and the information stored thereon being associated with a game entity that is controlled by a user in a video game that takes place in a virtual space, wherein the appearance of the physical object represents the game entity;
receive information indicating purchase of a customization for the video game at the point of purchase computing platform, the customization being associated with new content in the virtual space; and
effectuate storage of information corresponding to the new content, such storage effectuating implementation of the new content in the virtual space.

24. A method of customizing game entities played in a video game, the method being implemented in a computer system including one or more physical processors and storage media storing machine-readable instructions, the method comprising:
receiving information stored by a physical object from a reader operatively coupled to or included at a point of purchase computing platform located at a retail location, the physical object and the information stored thereon being associated with a game entity that is controlled by a user in a video game that takes place in a virtual space, wherein the appearance of the physical object represents the game entity;
receiving information indicating purchase of a customization for the video game at the point of purchase computing platform, the customization being associated with new content in the virtual space; and
effectuating storage of information corresponding to the new content, such storage effectuating implementation of the new content in the virtual space.
